(19) United States
(12) Patent Application Publication
(10) Pub. No.: US 2008/0283735 A1
(43) Pub. Date: Nov. 20, 2008

(54) Apparatus and a method for preventing a photographic image from being taken clearly

(76) Inventor: Dave Verenkoff, Henderson, NV (US)

Correspondence Address: REED SMITH LLP, Suite 1400, 3110 Fairview Park Drive, Falls Church, VA, 22042, US

(21) Appl. No.: 11/798,446

(22) Filed: May 14, 2007

(51) Int. Cl. G01J 1/44; G06M 7/00

(52) U.S. Cl. 250/221; 250/206

(57) ABSTRACT

An apparatus for preventing a photographic image from being taken clearly comprises a garment, optical sensors, strobes, a strobe controller and a battery. Each of the optical sensors is arranged on the garment so as to detect a flash from a camera in a different direction. Strobes are arranged on the garment. A strobe controller is coupled with the optical sensor and the strobes. The strobe controller flashes the strobes in response to an output of at least one of the optical sensors. A battery is coupled with the strobes, the strobe controller, and the optical sensor. The apparatus may comprise a manual switch coupled with the strobes. The manual switch is adapted to turn on and off the strobes manually.

### FIELD OF INVENTION

The invention generally relates to an apparatus for preventing photographic images from being taken clearly. More particularly, the invention relates to an apparatus for preventing a photographic image from being taken contrary to a target's desire.

### BACKGROUND OF THE INVENTION

Recently, many celebrities have trouble with paparazzi because the paparazzi chase them and take their photographs without permission, particularly in private situations. In many cases, a photographer is hiding in a place unknown to his target and taking photographs of the target. In other cases, a photographer may suddenly approach a target and take photographs of the target. Thus, a photographer's target has often no warning that the photographer is taking his/her photographs, or cannot predict when and where photographers may take his/her photographs. Consequently, he/she cannot evade the photographer.

One way to avoid prevent photographs from being taken against a person's desire is that he/she wears sunglasses or a wide brim hat so as to avoid photographers' noticing that he/she is the target. Another way is to disguise himself/herself with clothing which he/she usually does not wear. In these methods, however, the target cannot prevent his/her photographs from being taken clearly once a photographer does notice the target.

The objective of the present invention is to provide an apparatus and a method for preventing a photographer in any place from taking a clear photographic image of a user of the apparatus, i.e. the photographer's target, even if the user is unaware that the photographer is taking a photographic image.

Another objective of the present invention is to provide an apparatus and a method for preventing a photographer any place from taking a clear photographic image of the user of the apparatus in response to the user's initiation.

### SUMMARY OF THE INVENTION

The present invention provides an apparatus for preventing a photographic image from being taken clearly, comprising: a garment, optical sensors, each of the optical sensors being arranged on the garment so as to detect the flash from a camera; strobes arranged on the garment; a strobe controller for flashing the strobes in response to an output of at least one of the optical sensors, the strobe controller being coupled with the optical sensor and the strobes; and a battery coupled with the strobes, the strobe controller, and the optical sensor.

The present invention further provides that the strobe controller of the apparatus flashes the strobes repeatedly for a predetermined period.

The present invention further provides the apparatus comprises a manual switch coupled with the strobes, the manual switch being adapted for turning on and off the strobes manually.

The present invention further provides a method for preventing a photographic image from being taken clearly, comprising the steps of: detecting the flash from a camera by optical sensors, each of the optical sensors arranged on a garment so as to detect light in different directions; transmitting outputs of the optical sensors to a strobe controller; and flashing strobes arranged on the garment in response to at least one of the outputs, wherein each of the strobes faces a different direction.

The present invention further provides the method in which the strobes are flashed repeatedly for a predetermined period.

The present invention further provides a method for preventing a photographic image of a user of the apparatus from being taken clearly, comprising the steps of: turning on a manual switch coupled with strobes arranged on a garment; and flashing the strobes.

### BRIEF DESCRIPTION OF THE DRAWINGS

FIG. 1 is one embodiment of an apparatus for preventing a photographic image from being taken clearly according to the present invention.

FIG. 2 is another embodiment of an apparatus for preventing a photographic image from being taken clearly according to the present invention.

### DETAILED DESCRIPTION

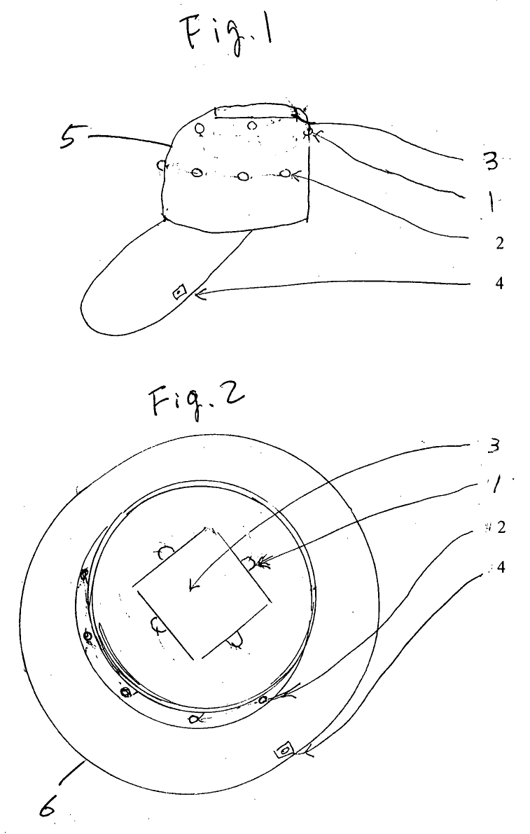

FIG. 1 shows one embodiment of an apparatus for preventing a photographic image from being taken clearly. The apparatus comprises a garment, optical sensors 1, strobes 2, a strobe controller 3, and a battery. In this embodiment, the garment is a baseball cap 5. Each of the optical sensors 1 is arranged on a baseball cap 5 so as to detect a flash from a camera in a different direction. Each of the strobes 2 are arranged at different points on the baseball cap 5. For example, as shown in FIG. 1, the strobes 2 are arranged on a circumference of a part of the baseball cap 5 which covers the head of a person. The placement of the strobes 2 is not limited to that shown in FIG. 1. The strobe controller 3 is coupled with the optical sensors 1 and the strobes 2 and arranged inside the baseball cap 5. A battery, which is not shown in FIG. 1, is coupled with the optical sensors 1, the strobes 2 and the strobe controller 3. Preferably, the battery is installed on or inside the baseball cap 5. Alternatively, the battery may be arranged apart from the baseball cap 5. The strobe controller 3 controls the strobes 2 in response to an output of at least one of the optical sensors 1. For example, when at least of one of the optical sensors 1 detects a flash from a camera, the output of the optical sensor 1 is transferred to the strobe controller 3, and then the strobe controller 3 flashes the strobes 2. The strobe controller 3 may flash all of the strobes 2 arranged on the baseball cap 5 in response to the output of at least one of the optical sensors, or at least one of the strobe arranged near the optical sensors which detects the flash from the camera. Once at least one of the optical sensors 1 detects a flash from a camera, the strobe controller 3 may flash the strobes 2 repeatedly for a predetermined period, because a photographer is likely to continue taking photographs of a person who wears the baseball cap 5, namely, his/her target.

A manual switch 4 may be arranged on the baseball cap 5. The manual switch 4 may be arranged on a part that can be easily accessed by the user, for example, a front brim or a side of the baseball cap 5. The user can turn on and off the strobes by turning on and off the manual switch 4 independently of the optical sensor's detection of a flash light. Alternatively, no manual switch is arranged on the baseball cap 5.

FIG. 2 shows another embodiment of an apparatus for preventing a photographic image from being taken clearly. In this embodiment, the garment is again a hat with a brim 6. The optical sensors 1 and the strobes 2 are arranged on the hat 6, preferably a hat 6 with a side brim. The strobe controller 3 is coupled with the optical sensors 1 and the strobes 2, and arranged inside the hat 6. A battery, which is not shown in FIG. 2, is coupled with the optical sensors 1, the strobes 2 and the strobe controller 3. Preferably, the battery is installed on or inside the hat 6. Alternatively, the battery may be arranged apart from the hat 6. As well as the embodiment described above, the strobe controller 3 controls the strobes 2 in response to an output of at least one of the optical sensors 1. For example, when at least of one of the optical sensors 1 detects the flash from a camera, the output of the optical sensor 1 is transferred to the strobe controller 3, and then the strobe controller 3 flashes the strobes 2. The strobe controller 3 may flash all of the strobes 2 arranged on the hat 6 in response to the output of at least one of the optical sensors, or at least one of the strobe arranged near the optical sensors which detects the flash from the camera. Once at least one of the optical sensors 1 detects a flash from a camera, the strobe controller 3 may flash the strobes 2 repeatedly for a predetermined period, because a photographer is likely to continue taking photographs of a person who wears the hat 6, namely, his/her target.

A manual switch 4 may be arranged on the hat 6. The manual switch 4 may be arranged on a part that can be easily accessed by the user, for example, on a brim or a side of the hat 6. The user can turn on and off the strobes by turning on and off the manual switch 4 independently of the optical sensor's detection of a camera flash. Alternatively, no manual switch is arranged on the hat 6.

The garment on which the apparatus of the present invention is not limited to a baseball cap or a hat. The apparatus of the present invention may be arranged on any kind of garment.

In the present invention, the strobes 2 on a garment which a user is wearing are automatically flashed in response to a flash from a camera carried by a photographer, or manually by the user, the images taken by the photograph being overexposed and therefore, the photographer cannot take clear photographs of the user. Also, in many cases, other photographers are chasing the same target on the same occasion. They will attempt to take photographs of the same target even after the first photographer fails to take his/her clear photographs. Since the strobes 2 can be flashed repeatedly for a predetermined period, other photographers will also be prevented from taking clear photographs of the user of the apparatus of the present invention.

What is claimed is:

1. An apparatus for preventing a photographic image from being taken clearly, comprising:
a garment;
optical sensors, each of the optical sensors being arranged in different directions on the garment so as to detect a flash from a camera;
strobes arranged on the garment;
a strobe controller coupled with the optical sensor and the strobes, the strobe controller being adapted to flash the strobes in response to an output of at least one of the optical sensors; and
a battery coupled with the strobes, the strobe controller, and the optical sensor.

2. The apparatus according to claim 1, wherein the strobes are arranged at different points of the garment.

3. The apparatus according to claim 1, wherein the strobe controller is adapted to flash the strobes repeatedly for a predetermined period.

4. The apparatus according to claim 1, comprising a manual switch coupled with the strobes, the manual switch configured to turn on and off the strobes manually.

5. The apparatus according to claim 4, the manual switch is arranged on the garment.

6. The apparatus according to claim 1, wherein the garment is a hat.

7. The apparatus according to claim 1, wherein the strobes are arranged on a circumference of a portion of the hat which covers a head of a user.

8. A method for preventing a photographic image from being taken clearly, comprising the steps of:
detecting a flash from a camera by optical sensors, each of the optical sensors arranged on a garment in a different direction so as to detect light from different direction;
transmitting outputs of the optical sensors to a strobe controller; and
flashing strobes arranged on the garment in response to at least one of the outputs,
wherein each of the strobes faces a different direction.

9. The method according to claim 8, wherein the strobes are flashed repeatedly for a predetermined period.

10. A method for preventing a photographic image from being taken clearly, comprising the steps of:
turning on a manual switch coupled with strobes arranged on a garment; and
flashing the strobes.

11. The method according to claim 10, wherein the strobes are flashed repeatedly for a predetermined period.
